(19) United States
(12) Patent Application Publication
(10) Pub. No.: US 2020/0154750 A1
(43) Pub. Date: May 21, 2020

(54) OIL- OR FAT-PROCESSED STARCH, COATING MATERIAL FOR FRIED FOOD USING THE SAME, FOOD AND METHOD FOR PRODUCING THE SAME

(71) Applicant: J-OIL MILLS, INC., Tokyo (JP)

(72) Inventors: Shogo KAWAI, Tokyo (JP); Masahiro INOUE, Tokyo (JP); Siripat JANARAM, Bangkok (TH); Wiranut WANWAROTHORN, Bangkok (TH); Chittapun ARAMWATTANANONT, Bangkok (TH); Natthanan SUBPUCH, Bangkok (TH)

(21) Appl. No.: 16/632,448

(22) PCT Filed: Jul. 9, 2018
(86) PCT No.: PCT/JP2018/025817

§ 371 Date: Jan. 20, 2020

(30) Foreign Application Priority Data
Jul. 21, 2017 (JP) 2017-142097

(51) Int. Cl. A23L 29/219; A23L 7/157; A23L 2/52; A23P 20/10

(52) U.S. Cl. CPC A23L 29/219; A23P 20/105; A23L 2/52; A23L 7/157

(57) ABSTRACT

An oil- or fat-processed starch obtainable by oil- or fat-processing a composition including component (A) corn starch, component (B) tapioca starch, component (C) edible oil or fat, and component (D) protein material, in which a blending amount of the component (B) with respect to a blending amount of the component (A) in the oil- or fat-processed starch is, as a mass ratio, ((B)/(A))=1/99 to 99/1.

### TECHNICAL FIELD

The present invention relates to an oil- or fat-processed starch, a coating material for fried food using the same, food and a method for producing the same.

### BACKGROUND ART

As a coating material for food such as fried food, wheat flour with little gluten is mainly used; however, since the adhesion between an ingredient and the coating after frying is not sufficient, the two come apart easily and deterioration in the appearance and eating-texture may lead to a decrease in product value.

In order to solve these issues, the use of oil- or fat-processed starch as a coating material was proposed. Oil- or fat-processed starch is a starch obtainable by mixing starch with oil or fat or oil- or fat-related substances and then carrying out drying or heating.

Patent Document 1 (Japanese Patent Laid-Open No. 62-14756) describes a technique in which oil- or fat-processed starch with a specific slurry viscosity, which is obtained by adding an edible oil or fat or related substance to a mixture of non-glutinous starch and glutinous starch or to glutinous starch alone and then carrying out processing, is used in a coating material for fried food, which makes it possible to obtain a uniform creamy batter having an appropriate viscosity at a high concentration. In addition, the same document describes that the batter has reasonably uniform attachment to the ingredient and also has good attachment of bread crumbs thereto, that the adhesion between the coating and the ingredient is good when fried with oil, and that it is possible to obtain a soft coating having a significantly improved eating-texture.

In addition, Patent Document 2 (Japanese Patent Application Laid-Open No. 2012-165724) describes using oil- or fat-processed acetylated tapioca starch, which is obtained by carrying out oil- or fat-processing on acetylated tapioca starch obtained by subjecting tapioca starch to acetylation with vinyl acetate, in a coating material for fried food, which makes it possible to make fried food which has a good succulent taste and for which the coating has an excellent eating-texture.

Furthermore, Patent Document 3 (Japanese Patent Application Laid-Open No. 2002-218920) describes using processed starch, which is obtained by heating a mixture obtained by blending oil, fat, and protein with starch without adding water, in a coating material for fried food and that the workability and adhesion between the coating and ingredient are excellent and it is possible to impart a soft eating-texture with a crispy coating to fried food.

### RELATED DOCUMENT

### Patent Document

[Patent Document 1] Japanese Patent Laid-Open No. 62-14756

[Patent Document 2] Japanese Patent Laid-Open No. 2012-165724 A

[Patent Document 3] Japanese Patent Laid-Open No. 2002-218920

### SUMMARY

### Technical Problem

However, even in a case where the materials described in each of the patent documents described above are used as coating materials, there is room for improvement in terms of improving the balance among the three points of a workability when handling a coating material, an adhesion between a coating and an ingredient (base food), and a preferable eating-texture of a contact layer of the coating with the ingredient.

### Solution to Problem

According to the present invention, there is provided an oil- or fat-processed starch obtainable by oil- or fat-processing a composition including components (A) to (D) below, in which a blending amount of the component (B) with respect to a blending amount of the component (A) in the composition is, as a mass ratio, ((B)/(A))=1/99 to 99/1.

(A) Corn starch

(B) Tapioca starch

(C) Edible oil or fat

(D) Protein material

In addition, according to the present invention, there is provided a coating material for fried food including the oil- or fat-processed starch according to the present invention.

In addition, according to the present invention, there is provided a food obtainable using the coating material for fried food according to the present invention.

In addition, according to the present invention, there is provided a method for producing food, the method including attaching the coating material for fried food of the present invention to an outer side of an ingredient.

Here, any combination of each of these components or any conversion of the implementation of the present invention between methods, devices, or the like is also valid as an aspect of the present invention.

For example, according to the present invention, there is provided a method for producing coating material for fried food, the method including obtaining oil or fat-processed starch by subjecting a composition including the components (A) to (D) to an oil or fat process, and obtaining a coating material for fried food, which is a predust or batter, blended with the oil- or fat-processed starch.

### Advantageous Effects of Invention

According to the present invention, it is possible to obtain favorable oil- or fat-processed starch in a coating material for fried food, which is excellent in the balance among the three points of the workability when handling the coating material, the adhesion between the coating and the ingredient, and the preferable eating-texture of the contact layer of the coating with the ingredient.

### DESCRIPTION OF EMBODIMENTS

A description will be given below of embodiments of the present invention with specific examples. It is possible to use each of the components alone or in a combination of two or more types.

In the present embodiment, the oil- or fat-processed starch refers to a starch material produced through steps provided with an operation of adding edible fats or oils to the raw starch and then carrying out mixing and heating.

In addition, in the present embodiment, the preferable eating-texture of the contact layer of the coating with the ingredient means a state where hardness or sliminess is not felt in the contact layer of the coating with the ingredient and which does not adversely affect the crispiness of the layer of the coating which does not contact the ingredient or the succulence of the ingredient.

In the present embodiment, the oil- or fat-processed starch is obtainable by oil- or fat-processing a composition including the components (A) to (D) below.

(A) Corn starch

(B) Tapioca starch

(C) Edible oil or fat

(D) Protein material

In the oil- or fat-processed starch of the present embodiment, a raw material starch in the composition includes specific components (A) and (B) at a specific ratio and the composition further includes (D). According to the present embodiment, using the oil- or fat-processed starch obtainable using these specific raw material starches together with the edible oil or fat of the component (C) makes it possible to improve the balance among the three points of the workability when handling the coating material for fried food (also simply referred to below as “coating material”), the adhesion between the coating and the ingredient, and the preferable eating-texture of the contact layer of the coating with the ingredient.

In addition, the oil- or fat-processed starch in the present embodiment is obtainable by oil- or fat-processing a composition including the components (A) to (D) and thus has an appropriate aggregability and the workability is good in that the attachment to the ingredient is excellent in a case of being handled as a predust and the batter viscosity is appropriately high in a case of being handled as a batter such that the attachment to the ingredient is excellent.

In addition, in a case where the coating material is a predust, for example, it is possible to improve the attachment of the predust to the ingredient and the adhesion between the ingredient and the coating. In addition, for example, it is possible to suppress a dry feeling and excessive hardening in the eating-texture of the ingredient.

In addition, even in a case where the coating material is a batter, it is possible to appropriately improve the viscosity of the batter and improve the attachment to the ingredient and the adhesion between the ingredient and the coating. In addition, for example, it is possible to suppress a dry feeling and excessive hardening in the eating-texture of ingredient.

A description will be given below of each component blended with the oil- or fat-processed starch.

Specific examples of the corn starch of component (A) include corn starch, waxy corn starch, high amylose corn starch, and processed starch thereof, and corn starch is preferable.

Specific examples of the tapioca starch of the component (B) include tapioca starch and processed starch thereof, and tapioca starch is preferable.

The mass ratio ((B)/(A)) of the blending amount of the component (B) to the blending amount of the component (A) in the composition is 1/99 or more from the viewpoint of improving the preferable eating-texture of the contact layer of the coating with the ingredient, preferably 10/90 or more, more preferably 20/80 or more, and even more preferably 35/65 or more. In addition, from the same viewpoint, the mass ratio ((B)/(A)) is 99/1 or less, preferably 97/3 or less, more preferably 95/5 or less, even more preferably 80/20 or less, yet more preferably 70/30 or less, and still more preferably 60/30 or less.

The total blending amount of the raw material starch including the components (A) and (B) in the composition is preferably 80% by mass or more with respect to the entire composition from the viewpoint of more stably obtaining adhesion between the coating and the ingredient, more preferably 84% by mass or more, even more preferably 87% by mass or more, and yet more preferably 90% by mass or more. In addition, from the same viewpoint, the total blending amount of the raw material starch including the components (A) and (B) in the composition is preferably 99.9% by mass or less with respect to the entire composition, more preferably 99.5% by mass or less, and even more preferably 99% by mass or less.

In addition, the raw material starch in the composition is preferably formed of components (A) and (B). Here, at this time, it is more preferable that the total amount of the components (A) and (B) in the composition is in the above range with respect to the entire composition.

Specific examples of the edible oil or fat of component (C) include soy oil, safflower oils such as high linoleic safflower oil, corn oil, rapeseed oil, perilla oil, linseed oil, sunflower oil, peanut oil, cotton seed oil, olive oil, rice oil, and palm oil. From the viewpoint of workability, a liquid oil is preferably used as an edible oil or fat and one or two or more liquid oils selected from the group formed of soy oil, rapeseed oil, corn oil, high linoleic safflower oil, linseed oil, and perilla oil are more preferable.

In addition, as the edible fats and oils, it is more preferable to use fats and oils having an iodine value of 100 or more and even more preferable to use fats and oils having an iodine value of 135 or more. Fats and oils having a high iodine value are susceptible to oxidation by heating, have a strong reforming effect on raw material starch, and make it possible to expect further improvement in the adhesion to the ingredient when blended in the coating material. Specific examples of fats and oils having an iodine value of 135 or more include high linoleic safflower oil, linseed oil, and perilla oil. There is no upper limit for the iodine value of edible fats and oils and, for example, the upper limit may be 250 or less.

From the viewpoint of more reliably obtaining the effect of reforming the raw material starch, the blending amount of component (C) in the composition is preferably 0.005 parts by mass or more when the total of the raw material starch including components (A) and (B) is 100 parts by mass, more preferably 0.01 parts by mass or more, even more preferably 0.02 parts by mass or more, and yet more preferably 0.05 parts by mass or more. In addition, from the viewpoint of more stably obtaining the adhesion between the coating and the ingredient, the blending amount of the component (C) is preferably 5 parts by mass or less when the total amount of the raw material starch is 100 parts by mass, more preferably 4 parts by mass or less, even more preferably 2 parts by mass or less, and yet more preferably 1 part by mass or less.

Examples of the protein material of component (D) include natural protein materials which contain high amounts of plant proteins, animal proteins, or the like, crude purified proteins derived from natural protein materials, purified proteins, and the like. Examples of plant proteins include seed proteins such as wheat protein, soy protein, and corn protein, and the like. Examples of animal proteins include egg proteins such as egg white protein and egg yolk protein, milk proteins such as whey protein and casein, blood proteins such as plasma protein and blood cell protein, muscle proteins such as meat protein and fish protein, and the like.

From the viewpoint of further increasing the balance among each of the three effects of the workability when handling the coating material, the adhesion between the coating and the ingredient, and the preferable eating-texture of the contact layer of the coating with the ingredient, the component (D) preferably includes one type or two or more types selected from the group formed of plant proteins such as soy protein and wheat protein; and animal proteins such as milk protein, egg protein, and gelatin, and more preferably includes soy protein. Examples of soy protein include defatted soy flour, full fat soy flour, concentrated soy protein, separated soy protein, and the like, and defatted soy flour is preferable.

From the viewpoint of more reliably obtaining the effect of reforming the raw material starch, the blending amount of the component (D) in the composition is preferably 0.1 part by mass or more when the total amount of the raw material starch including the components (A) and (B) is 100 parts by mass, more preferably 0.5 parts by mass or more, and even more preferably 1 part by mass or more. In addition, from the viewpoint of more stably obtaining the adhesion between the coating material and the ingredient, the blending amount of the component (D) is preferably 20 parts by mass or less when the total amount of the raw material starch is 100 parts by mass, more preferably 15 parts by mass or less, and even more preferably 10 parts by mass or less.

Next, a description will be given of the method for producing the oil- or fat-processed starch in the present embodiment.

The oil- or fat-processed starch is obtainable using the components (A) to (D) described above and other components as appropriate, for example, by a production method including the following steps.

(First step) mixing components (A) to (D) to prepare a composition including the components (A) to (D) and

(Second step) heat-processing the composition obtained in the first step.

In the first step, the mixing order of the components is not limited, but, preferably, the components other than the component (C) are mixed, then the component (C) is added thereto and further mixed.

In the second step, the oil- or fat-processed starch is obtainable by heating the composition obtained in the first step.

From the viewpoint of more stably obtaining adhesion between the coating and the ingredient, the heating process is preferably performed at 130° C. or lower, more preferably 120° C. or lower, even more preferably 105° C. or lower, and yet more preferably 90° C. or lower. The lower limit of the heating temperature is not limited, but from the viewpoint of improving the productivity by appropriately shortening the days for aging, the lower limit is, for example, 40° C. or higher, preferably 45° C. or higher, and more preferably 55° C. or higher.

The period of the heating process is appropriately set according to the state of the obtainable oil- or fat-processed starch and the heating temperature. From the viewpoint of more stably obtaining the adhesion between the coating and the ingredient, the heating period is, for example, 0.5 hours or more, preferably 5 hours or more, more preferably 6 hours or more, and even more preferably 24 hours or more. In addition, from the same viewpoint, the upper limit of the heating period is, for example, 25 days or less, preferably 20 days or less, and more preferably 18 days or less.

It is possible to obtain oil- or fat-processed starch by the above procedure. The obtainable oil- or fat-processed starch is suitable as a coating material for fried food such as predust, batter, and breader, and specifically suitable as predust or batter.

The predust is a coating material used in combination with batter. For example, the predust is used on the ingredient before attaching the batter. For the ingredient where the coating and the ingredient come apart easily, for example, for meat, seafood products, and the like subjected to a heating process, using predust makes it possible to more effectively suppress separation of the coating and the ingredient.

In the present embodiment, from the viewpoint of improving workability during handling of the predust, the viewpoint of improving the adhesion between the coating and the ingredient, and the viewpoint of improving the eating-texture of the contact layer of the coating with the ingredient, the content of the oil- or fat-processed starch in the predust is preferably 50% by mass or more with respect to the entirety of the predust, and more preferably 80% by mass or more, and may be, for example, 100% by mass or less with no upper limit.

In addition, the batter is a liquid coating material and the batter may be attached directly to the ingredient or the batter may be attached to the predusted ingredient.

In the present embodiment, from the viewpoint of improving the workability during handling of the batter, the viewpoint of improving the adhesion between the coating and the ingredient, and the viewpoint of improving the eating-texture of the portion between the coating and the ingredient, the content of the oil- or fat-processed starch in the batter is preferably 50% by mass or more with respect to the solid content in the batter, and more preferably 70% by mass or more, and may be, for example, 100% by mass or less with no upper limit.

In addition, the breader is a powdered coating material which forms the outermost layer of fried food. For example, if a breader is attached directly to the ingredient, the breader may be attached after attaching batter to the ingredient or the breader may be attached after attaching batter after applying predust to the ingredient.

Here, components other than the oil- or fat-processed starch may be included in the coating material in the present embodiment. Examples of other components include starches other than the oil- or fat-processed starch in the present embodiment, such as corn starch; polysaccharides other than the above, such as xanthan gum, and other viscosity modifiers; cereal flours such as wheat flour, rice flour, and corn flour; proteins such as soy protein, milk protein, egg white, and egg yolk; seasonings such as mirin, soy sauce, salt, and spices; oils and fats such as animal and vegetable oils and fats and powder oils and fats; emulsifiers such as lecithin and glycerin fatty acid esters; and expanding agents such as baking powder.

The food in the present embodiment includes food including the coating material for fried food in the present embodiment or food made using the coating material for fried food in the present embodiment, and, more specifically, food obtainable by attaching the coating material for fried food in the present embodiment to an ingredient. That is, specifically, the food in the present embodiment is food which is deep-fried (-like) food.

There may be one type or two or more types of coating material in the food. For example, it is possible to have a food including one type or more selected from the group formed of predust and batter as the coating material.

Examples of one type or two or more types of coating materials include predust and batter combinations; predust, batter, and bread crumb combinations; predust, batter, and breader combinations; batter; batter and bread crumb combinations; and batter and breader combinations.

When a plurality of coating materials are used in combination, a plurality of coating materials including the specific oil- or fat-processed starch in the present embodiment may be used in combination.

For example, in a food including predust and batter as a coating material, it is possible for either the predust or the batter to be the coating material including the specific oil- or fat-processed starch. From the viewpoint of more stably improving the adhesion with the ingredient, it is preferable to use both the predust and the batter as the coating material of the present embodiment, which includes the specific oil- or fat-processed starch.

In addition, it is preferable to use a combination of a coating material including the specific oil- or fat-processed starch and another coating material, and it is more preferable to attach the other coating material after attaching the coating material including the specific oil- or fat-processed starch to an ingredient. Here, the other coating material means a coating material which does not include the specific oil- or fat-processed starch, and the other coating material may be in the form of a batter, a breader, bread crumbs, or the like.

The method for producing food in the present embodiment includes, for example, a step of attaching the predust described above to the outer side of an ingredient. In addition, the method for producing food in present embodiment includes a step of attaching the batter described above to the outer side of an ingredient, for example. The present embodiment also includes a production method which uses both the predust and the batter described above. In such a case, it is preferable to include attaching the predust to the outer side of the ingredient and attaching the batter to the outer side of the ingredient thereafter.

There is no limitation on the cooking method when cooking with heat and, for example, it is also possible to use the method for fried food obtainable by deep-frying the coating material of the present embodiment, or it is also possible to use the method for a so-called non-fried food, that is, food like deep-fried food. Specific examples of the food like fried food include food obtainable by baking in an oven or steam heating.

Examples of the food in the present embodiment include fried food with bread crumb coatings; karaage such as karaage and tatsuta-age; tempura such as tempura and kakiage; and fritters.

Among these, examples of fried foods with a bread crumb coating are more specifically croquettes such as potato croquettes and cream croquettes, pork cutlets, minced meat cutlets, beef cutlets, chicken cutlets, and ham cutlets; and fried seafood such as fried shrimp and fried squid.

In addition, specific examples of the ingredient to which the coating material for fried food is attached include meat such as pork, chicken, beef, and processed meat products; seafood products such as shrimp, squid, shellfish such as oysters and scallops, fish such as horse mackerel, and other seafood and marine products; as well as produce such as vegetables.

In actual food production, meat is subjected to a heating process (for example, a steaming process) from the viewpoint of hygiene and, even though the adhesion between the meat subjected to a heating process and the coating is significantly inferior to raw meat, the coating material of the present embodiment also makes it possible to obtain sufficient adhesion, even with meat subjected to a heating process.

### EXAMPLES

### Example 1

In 95 parts by mass of corn starch (Cornstarch Y, produced by J-Oil Mills, Inc.) and 5 parts by mass of tapioca starch (produced by J-Oil Mills, Inc.), 0.1 parts by mass of high linoleic safflower oil (iodine value 150) and 1 part of defatted soy flour (Nikka Milky S, produced by J-Oil Mills, Inc.) were mixed uniformly for 3 minutes at 2000 rpm with a mixer (Super mixer, manufactured by Kawata MFG. Co., Ltd.), to obtain a mixture (water content 12.5% by mass). This mixture was heated at 70° C. for 14 days in a shelf-type drying machine to obtain an oil- or fat-processed starch. Table 1 shows the preparation conditions of the oil- or fat-processed starch.

The powder properties and the attachment to the ingredient of the obtained oil- or fat-processed starch were evaluated by the following methods. The evaluation results are also shown in Table 1.

### (Powder Properties)

Aggregability (%) was evaluated using a powder property evaluation apparatus (product name: Powder Tester PT-E, manufactured by Hosokawa Micron Corporation). The basic operation method followed the instruction manual of the above apparatus. A high aggregability value is an indicator of good attachment to an ingredient in a case of being used as a predust. In addition, since it is possible to increase the viscosity appropriately in a case of being used as a batter, this is an indicator that the attachment to an ingredient is good. In this Example, an aggregability of 21% or more was a pass.

### Examples 2-5, Comparative Examples 1-3

Except for changing the blend and conditions shown in Table 1, coating materials made of the oil- or fat-processed starch of each Example were prepared with the same method as in Example 1 and the powder properties were evaluated with the same method as in Example 1. The evaluation results are also shown in Table 1.

For waxy corn starch, waxy corn starch Y (produced by J-Oil Mills, Inc.) was used.

TABLE 1

| | | Comparative | | | | | Comparative | | Comparative |
|---|---|---|---|---|---|---|---|---|---|
| | | Example 1 | Example 1 | Example 2 | Example 3 | Example 4 | Example 2 | Example 5 | Example 3 |
| Blending | Corn starch | 100 | 95 | 70 | 50 | 20 | | 50 | 5 |
| (parts by | Tapioca starch | | 5 | 30 | 50 | 80 | 100 | 50 | |
| mass) | High linoleic | 0.1 | 0.1 | 0.1 | 0.1 | 0.1 | 0.1 | 3 | 0.2 |
| | safflower oil | | | | | | | | |
| | Defatted soy flour | 1 | 1 | 1 | 1 | 1 | 1 | 10 | |
| | Waxy corn starch | | | | | | | | 95 |
| Heating process condition | | 70° C. for | 70° C. for | 70° C. for | 70° C. for | 70° C. for | 70° C. for | 70° C. for | 70° C. for |
| | | 14 days | 14 days | 14 days | 14 days | 14 days | 14 days | 14 days | 14 days |
| Evaluation | Powder Properties | 20.3 | 25.5 | 26.9 | 33 | 28.1 | 15.5 | 66.7 | 17.9 |
| results | (Aggregability %) | | | | | | | | |

In Table 1, all of the oil- or fat-processed starches of Examples 1 to 5 had high aggregability.

On the other hand, the oil- or fat-processed starches of Comparative Example 1 prepared using only corn starch as the raw material starch and of Comparative Example 2 prepared using only tapioca starch had low aggregability. In addition, the oil- or fat-processed starch of Comparative Example 3 prepared by mixing corn starch and waxy corn starch as corn starch without adding defatted soy flour also had low aggregability.

In the following Examples, fried foods were prepared using the oil- or fat-processed starches obtained in Examples 1 to 5 and Comparative Examples 1 to 3 in the coating materials thereof and evaluated.

Below, for the evaluation of the eating-texture, in all cases, each piece of each fried food was entirely eaten after evaluating the adhesion of the coating and the ingredient and the eating-texture of the adhesive layer of the coating with the ingredient and the eating-texture of the ingredient were expressed as an average evaluation according to the consensus of three expert judges.

### Examples 2-1 to 2-5, Comparative Examples 2-1 to 2-3

In these Examples, pork cutlets were prepared using predust made of the oil- or fat-processed starch obtained in Examples 1 to 5 and Comparative Examples 1 to 3 and evaluated.

Frozen pork (approximately 80 g) was coated with approximately 4 parts by mass of a sample of an oil- or fat-processed starch obtained in each Example as a predust per 100 parts by mass of the pork, then batter (a liquid in which 100 parts by mass of flour were mixed in 200 parts by mass of ice-cold water) was attached thereto, bread crumbs were attached thereto, then the result was frozen and stored overnight, and then deep-fried in canola oil at 170° C. for five minutes to obtain a pork cutlet. The adhesion and eating-texture of the obtained pork cutlet were evaluated. The evaluation results are shown in Table 2.

### (Predust Attachment)

Frozen pork (approximately 80 g) was coated with approximately 4 parts by mass of a sample of an oil- or fat-processed starch obtained in each Example as a predust per 100 parts by mass of the pork and the ease with which the predust was attached was expressed as an average evaluation according to the consensus of three expert judges. The evaluation criteria are shown below. In the following, B or better was a pass.

AA: Very good attachment to ingredient

A: Good attachment to ingredient

B: Reasonable attachment to ingredient

C: Poor attachment to ingredient

### (Adhesion)

The adhesion between the coating and the ingredient was evaluated by the following procedure.

That is, one minute after deep-frying, the food was cut into five equal parts and food where the coating and the ingredient did not come apart at the four cut surfaces was given 1 point, food which partly came apart was given 0.5 point, and food where everything came apart was given 0 points. Two pieces of pork cutlet (with predust) were evaluated for a total of eight cut surfaces (with a maximum score of 8 points). The total score of the evaluation of the eight cut surfaces/8 points×100 (%) was calculated and 60% or more was a pass.

### (Eating-Texture)

The eating-texture of the contact layer of the coating with the meat in the pork cutlet was evaluated according to the following criteria and B or better was a pass.

A: Does not feel slimy or hard

B: Some sliminess or hardness is felt

C: Feels slimy or hard

In addition, the eating-texture of the meat portion in the pork cutlet was evaluated according to the following criteria and B or better was a pass.

A: Appropriately soft and succulent

B: Somewhat soft and succulent

C: Hard and dry

TABLE 2

| | | Comparative | Example | Example | Example | Example | Comparative | Example | Comparative |
|---|---|---|---|---|---|---|---|---|---|
| | | Example 2-1 | 2-1 | 2-2 | 2-3 | 2-4 | Example 2-2 | 2-5 | Example 2-3 |
| Oil- or fat-processed starch | | Comparative | Example 1 | Example 2 | Example 3 | Example 4 | Comparative | Example 5 | Comparative |
| used as predust | | Example 1 | | | | | Example 2 | | Example 3 |
| Evaluation | Predust | C | A | A | A | A | C | AA | C |
| results | Attachment | | | | | | | | |
| | Pork cutlet | 56.3% | 75.0% | 87.5% | 100.0% | 93.8% | 50.0% | 62.5% | 25.0% |
| | adhesion | | | | | | | | |
| | Eating-texture of | C | B | A | A | B | C | A | C |
| | contact layer of | | | | | | | | |
| | coating with meat | | | | | | | | |
| | of pork cutlet | | | | | | | | |
| | Eating-texture of | C | A | A | A | A | C | B | C |
| | meat portion of | | | | | | | | |
| | pork cutlet | | | | | | | | |

As shown in Table 2, in Examples 2-1 to 2-5 obtained using the oil- or fat-processed starch obtained in Examples 1 to 5 as the predust in a pork cutlet, the attachment of the predust to the ingredient was good and the adhesion was good. Among the above, Example 2-3, in which corn starch and tapioca starch were added at a mass ratio of 50:50, exhibited the best adhesion. In addition, Example 2-2 and Example 2-3 were good, sliminess or hardness was not felt in the contact layer of the coating with the meat of the pork cutlet, the eating-texture of the bread crumbs and meat was not adversely affected, and the eating-texture of the meat portion in the pork cutlet was also succulent and soft.

On the other hand, in Comparative Example 2-1 obtained using the oil- or fat-processed starch obtained in Comparative Example 1 as a predust on a pork cutlet, the attachment of the predust to the ingredient was poor, the adhesion was also weak, hardness was felt in the contact layer of the coating with the meat of the pork cutlet, the eating-texture of the bread crumbs and meat was adversely affected, and the eating-texture of the meat portion of the pork cutlet was also inferior, being hard and dry. In addition, in Comparative Examples 2-2 and 2-3 obtained using the oil- or fat-processed starches obtained in Comparative Examples 2 and 3 as a predust on a pork cutlet, the attachment of the predust to the ingredient was poor, the adhesion was also low, sliminess was felt in the contact layer of the coating with the meat in the pork cutlet, the eating-texture of the meat and the bread crumbs was adversely affected, and the eating-texture of the meat portion of the pork cutlet was also inferior, being hard and dry.

### Examples 3-1 to 3-5, Comparative Examples 3-1 to 3-3

In these Examples, pork cutlets were prepared using batters including the oil- or fat-processed starch obtained in Examples 1 to 5 and Comparative Examples 1 to 3 and evaluated.

After thoroughly mixing 90 g of a sample of the oil- or fat-processed starch obtained in each Example, 9.6 g of corn starch, and 0.4 g of xanthan gum (Echo Gum F, produced by DSP Gokyo Food & Chemical Co., Ltd.), 190 g of ice-cold water was added thereto and thoroughly mixed, and the result was used as batter. The batter was attached to frozen pork (approximately 80 g), bread crumbs were further attached thereto, then the result was frozen and stored overnight, then deep-fried at 170° C. for 5 minutes in canola oil to obtain a pork cutlet. The evaluation results are shown in Table 3.

### (Batter Attachment)

The ease of attachment when attaching the batter including the oil- or fat-processed starch obtained in each Example to frozen pork (approximately 80 g) was expressed as an average evaluation according to the consensus of three expert judges. The evaluation criteria are shown below. In the following, B or better was a pass.

AA: Very good attachment to ingredient

A: Good attachment to ingredient

B: Reasonable attachment to ingredient

C: Poor attachment to ingredient

### (Adhesion)

The adhesion between the coating and the ingredient was evaluated by the following procedure.

One minute after deep-frying, the food was cut into five equal parts and food where the coating and ingredient did not come apart at the four cut surfaces was given 1 point, food which partly came apart was given 0.5 point, and food where everything came apart was given 0 points. A total of four cut surfaces were evaluated for one pork cutlet (with a maximum score of 4 points). The total score of the evaluation of the four cut surfaces/4 points×100 (%) was calculated and 60% or more was a pass.

### (Eating-Texture)

The eating-texture of the contact layer of the coating with the meat of the pork cutlet was evaluated according to the following criteria and B or better was a pass.

A: No sliminess or hardness was felt

B: Some sliminess or hardness was felt

C: Sliminess or hardness was felt

In addition, the eating-texture of the meat portion in the pork cutlet was evaluated according to the following criteria and B or better was a pass.

A: Appropriately soft and succulent

B: Slightly soft and succulent

C: Hard and dry

TABLE 3

| | | Comparative | Example | Example | Example | Example | Comparative | Example | Comparative |
|---|---|---|---|---|---|---|---|---|---|
| | | Example 3-1 | 3-1 | 3-2 | 3-3 | 3-4 | Example 3-2 | 3-5 | Example 3-3 |
| Oil- or fat-processed starch | | Comparative | Example 1 | Example 2 | Example 3 | Example 4 | Comparative | Example 5 | Comparative |
| used in batter | | Example 1 | | | | | Example 2 | | Example 3 |
| Evaluation | Batter Attachment | C | B | B | A | A | C | AA | C |
| results | Pork cutlet | 50.0% | 87.5% | 87.5% | 100.0% | 87.5% | 50.0% | 87.5% | 25.0% |
| | adhesion | | | | | | | | |
| | Eating-texture of | | | | | | | | |
| | contact layer of | C | B | A | A | B | C | A | C |
| | coating with meat | | | | | | | | |
| | of pork cutlet | | | | | | | | |
| | Eating-texture of | | | | | | | | |
| | meat portion of | C | A | A | A | A | C | B | C |
| | pork cutlet | | | | | | | | |

As shown in Table 3, in Examples 3-1 to 3-5 obtained using the oil- or fat-processed starch obtained in Examples 1 to 5 as a batter in a pork cutlet, the batter attachment was good and the adhesion was good. Among the above, Example 3-3, in which corn starch and tapioca starch were added at a mass ratio of 50:50, exhibited the best adhesion. In addition, in Examples 3-2 and 3-3, sliminess or hardness was not felt in the contact layer of the coating with the meat of the pork cutlet and the eating-texture of the meat portion of the pork cutlet was also succulent and soft.

On the other hand, in Comparative Example 3-1 obtained using the oil- or fat-processed starch obtained in Comparative Example 1 as a batter in a pork cutlet, the batter attachment was poor, hardness was felt in the contact layer of the coating with the meat of the pork cutlet, and the eating-texture of the meat portion of the pork cutlet was hard and inferior. In addition, in Comparative Examples 3-2 and 3-3 obtained using the oil- or fat-processed starches obtained in Comparative Examples 2 and 3 as batter in a pork cutlet, the batter attachment was poor, sliminess was felt in the contact layer of the coating with the meat of the pork cutlet, and the eating-texture of the meat portion of the pork cutlet was also hard and inferior.

### Example 4-1 and Comparative Examples 4-1 and 4-2

In these Examples, fried shrimp were prepared using predust made of the oil- or fat-processed starches obtained in Example 3 and Comparative Examples 1 and 2 and evaluated.

Thawed shrimp (approximately 11 g/1 piece) with stretched out tails were coated with approximately 5 parts by mass of a sample of an oil- or fat-processed starch obtained in each Example as a predust per 100 parts by mass of shrimp, then batter (a liquid in which 100 parts by mass of fine flour were mixed in 150 parts by mass of ice-cold water) was attached thereto, bread crumbs were further added thereto, then the result was frozen and stored overnight, and then deep-fried in canola oil at 170° C. for two minutes to obtain fried shrimp. The adhesion and eating-texture of the obtained fried shrimp were evaluated. The evaluation results are shown in Table 4.

### (Adhesion)

The adhesion between the coating and the ingredient was evaluated by the following procedure.

One minute after deep-frying, the food was cut in half vertically between the head side and tail side and food where the coating and the ingredient did not come apart at the cut surfaces was given 1 point, food which partly came apart was given 0.5 point, and food where everything came apart was given 0 points. Three fried shrimp and a total of three cut surfaces were evaluated (with a maximum score of 3 points). The total score of the evaluation of the three cut surfaces/3 points×100 (%) was calculated and 60% or more was a pass.

### (Eating-Texture)

The eating-texture of the contact layer of the coating with the shrimp in the fried shrimp was evaluated according to the following criteria and B or better was a pass.

A: Hardness and sliminess are not felt

B: Some sliminess or hardness is felt

C: Sliminess or hardness is felt

In addition, the eating-texture of the shrimp portion in the fried shrimp was evaluated according to the following criteria and B or better was considered to be a pass.

A: Moist and succulent

B: Slightly moist and succulent

C: Dry

TABLE 4

| | | Example | Comparative | Comparative |
|---|---|---|---|---|
| | | 4-1 | Example 4-1 | Example 4-2 |
| Oil- or fat-processed starch | | Example 3 | Comparative | Comparative |
| used as predust | | | Example 1 | Example 2 |
| Evaluation | Fried shrimp | 66.7% | 33.3% | 16.7% |
| results | adhesion | | | |
| | Eating-texture of | A | C | C |
| | contact layer of | | | |
| | coating with meat | | | |
| | of fried shrimp | | | |
| | Eating-texture of | A | B | B |
| | meat portion of | | | |
| | fried shrimp | | | |

As shown in Table 4, in Example 4-1, which was obtained using the oil- or fat-processed starch obtained in Example 3 as a predust on fried shrimp, the adhesion was good and hardness and sliminess were not felt in the contact layer of the coating with the shrimp in the fried shrimp, and the eating-texture of the shrimp portion of the fried shrimp was moist and succulent.

On the other hand, in Comparative Example 4-1 obtained using the oil- or fat-processed starch obtained in Comparative Example 1 as a predust on fried shrimp, the adhesion was low, hardness was felt in the contact layer of the coating with the shrimp in the fried shrimp, the eating-texture of the bread crumbs and the shrimp was adversely affected, and the eating-texture of the shrimp portion of the fried shrimp was also inferior in moistness in comparison with Example 4-1. In addition, in Comparative Example 4-2 obtained using the oil- or fat-processed starch obtained in Comparative Example 2 as a predust on fried shrimp, the adhesion was low, sliminess was felt in the contact layer of the coating with the shrimp in the fried shrimp, the eating-texture of the bread crumbs and the shrimp was adversely affected, and the eating-texture of the shrimp portion of the fried shrimp was also inferior in moistness in comparison with Example 4-1.

### Example 5-1 and Comparative Example 5-1

In these Examples, karaage (fried chicken) was prepared using predust made of the oil- or fat-processed starch obtained in Example 4 and Comparative Example 2 and evaluated.

Chicken thigh meat (skinless, approximately 20 g) was coated with approximately 10 parts by mass of a sample of an oil- or fat-processed starch obtained in each Example as a predust per 100 parts by mass of meat, then batter (a liquid in which 100 parts by mass of fine flour, 2 parts by mass of salt, 2 parts by mass of sugar, and 150 parts by mass of ice-cold water were mixed) was attached thereto, then the result was deep-fried in canola oil at 170° C. for four minutes to obtain karaage. The evaluation results are shown in Table 5.

### (Adhesion)

The adhesion between the coating and the ingredient was evaluated by the following procedure.

One minute after deep-frying, the food was cut in half and food where the coating and ingredient did not come apart at the cut surfaces was given 1 point, food which partly came apart was given 0.5 point, and food where everything came apart was given 0 points. Three pieces of karaage and a total of three cut surfaces were evaluated (with a maximum score of 3 points). The total score of the evaluation of the three cut surfaces/3 points×100 (%) was calculated and 60% or more was a pass.

### (Eating-Texture)

The eating-texture of the contact layer of the coating with the meat in the karaage was evaluated according to the following criteria and B or better was a pass.

A: Sliminess is not felt

B: Some sliminess is felt

C: Sliminess is felt

In addition, the eating-texture of the meat portion in the karaage was evaluated according to the following criteria and B or better was a pass.

A: Appropriately soft and succulent

B: Somewhat soft and succulent

C: Hard and dry

TABLE 5

| | | | Comparative |
|---|---|---|---|
| | | Example 5-1 | Example 5-1 |
| Oil- or fat-processed starch used as | | Example 4 | Comparative |
| predust | | | Example 2 |
| Evaluation | Fried chicken adhesion | 83.3% | 55.6% |
| results | Eating-texture of contact | | |
| | layer of coating with meat | A | C |
| | of karaage | | |
| | Eating-texture of meat | A | C |
| | portion of karaage | | |

As shown in Table 5, in Example 5-1, which was obtained using the oil- or fat-processed starch obtained in Example 4 as a predust on karaage, the adhesion was good, sliminess was not felt in the contact layer of the coating with the meat of the karaage, and the eating-texture of the meat portion of the karaage was also soft and succulent.

On the other hand, in Comparative Example 5-1, which was obtained using the oil- or fat-processed starch obtained in Comparative Example 2 as a predust on karaage, the adhesion was low, sliminess was felt in the contact layer of the coating with the meat of the karaage, and the eating-texture of the meat portion of the karaage was inferior, being hard and dry.

### Example 6-1 and Comparative Example 6-1

In these Examples, a chicken cutlet was prepared using predust made of the oil- or fat-processed starches obtained in Example 4 and Comparative Example 2 and evaluated.

A chicken cutlet was prepared according to the preparation procedure of Example 2-1 except that chicken thigh meat (skinless, approximately 100 g) was used instead of frozen pork (approximately 80 g) in the preparation procedure of Example 2-1. The evaluation results are shown in Table 6.

### (Adhesion)

The adhesion between the coating and the ingredient was evaluated by the following procedure.

One minute after frying, the food was cut into five equal parts and food where the coating and the ingredient did not come apart at the four cut surfaces was given 1 point, food which partly came apart was given 0.5 point, and food where everything came apart was given 0 points. One piece of chicken cutlet and a total of four cut surfaces were evaluated (with a maximum score of 4 points). The total score of the evaluation of four cut surfaces/4 points×100 (%) was calculated and 60% or more was a pass.

### (Eating-Texture)

The eating-texture of the contact layer of the coating with the meat of the chicken cutlet was evaluated according to the following criteria and B or better was a pass.

A: Sliminess is not felt

B: Some sliminess is felt

C: Sliminess is felt

In addition, the eating-texture of the meat portion in the chicken cutlet was evaluated according to the following criteria and B or better was a pass.

A: Appropriately soft and succulent

B: Slightly soft and succulent

C: Hard and dry

TABLE 6

| | | | Comparative |
|---|---|---|---|
| | | Example 6-1 | Example 6-1 |
| Oil- or fat-processed starch used as | | Example 4 | Comparative |
| predust | | | Example 2 |
| Evaluation | Chicken cutlet adhesion | 87.5% | 37.5% |
| results | Eating-texture of contact | A | C |
| | layer of coating with meat | | |
| | of chicken cutlet | | |
| | Eating-texture of meat | A | C |
| | portion of chicken cutlet | | |

As shown in Table 6, in Example 6-1, which was obtained using the oil- or fat-processed starch obtained in Example 4 as a predust on a chicken cutlet, the adhesion was good, sliminess was not felt in the contact layer of the coating with the meat of the chicken cutlet, and the eating-texture of the meat portion of the chicken cutlet was appropriately soft and succulent.

On the other hand, in Comparative Example 6-1, which was obtained using the oil- or fat-processed starch obtained in Comparative Example 2 as a predust on a chicken cutlet, the adhesion was low, sliminess was felt in the contact layer of the coating with the meat of the chicken cutlet, and the eating-texture of the meat portion of the chicken cutlet was also inferior, being dry.

This application claims priority based on Japanese Patent Application No. 2017-142097 filed on Jul. 21, 2017, the entire disclosure of which is incorporated herein.

1. An oil- or fat-processed starch obtainable by oil- or fat-processing a composition including components (A) to (D) below,
wherein a blending amount of the component (B) with respect to a blending amount of the component (A) in the composition is, as a mass ratio, ((B)/(A))=1/99 to 99/1,
(A) Corn starch
(B) Tapioca starch
(C) Edible oil or fat
(D) Protein material.

2. The oil- or fat-processed starch according to claim 1,
wherein the component (D) includes soy protein.

3. The oil- or fat-processed starch according to claim 1,
wherein a total amount of the component (A) and the component (B) in the composition is 80% by mass or more to 99.9% by mass or less with respect to the whole composition.

4. A coating material for fried food comprising:
the oil- or fat-processed starch according to claim 1.

5. The coating material for fried food according to claim 4,
wherein the coating material for fried food is predust.

6. The coating material for fried food according to claim 4,
wherein the coating material for fried food is batter.

7. Food obtainable using the coating material for fried food according to claim 4.

8. A method for producing food, the method comprising:
attaching the coating material for fried food according to claim 4 to an outer side of an ingredient.

9. A method for producing food, the method comprising:
attaching a coating material for fried food to an outer side of an ingredient, the coating material for fried food comprising:
an oil- or fat-processed starch obtainable by oil- or fat-processing a composition including components (A) to (D) below,
wherein a blending amount of the component (B) with respect to a blending amount of the component (A) in the composition is, as a mass ratio, ((B)/(A))=1/99 to 99/1,
(A) Corn starch,
(B) Tapioca starch,
(C) Edible oil or fat, and
(D) Protein material, and
wherein the coating material for fried food is predust; and
attaching a coating material for fried food thereafter, the coating material for fried food comprising:
an oil- or fat-processed starch obtainable by oil- or fat-processing a composition including components (A) to (D) below,
wherein a blending amount of the component (B) with respect to a blending amount of the component (A) in the composition is, as a mass ratio, ((B)/(A))=1/99 to 99/1,
(A) Corn starch,
(B) Tapioca starch,
(C) Edible oil or fat, and
(D) Protein material, and
wherein the coating material for fried food is batter.
